(19) United States
(12) Patent Application Publication
(10) Pub. No.: US 2020/0212450 A1
(43) Pub. Date: Jul. 2, 2020

(54) ELECTRODE FOR SOLID STATE BATTERY AND SOLID STATE BATTERY

(71) Applicant: Honda Motor Co.,Ltd., Tokyo (JP)

(72) Inventors: Wataru SHIMIZU, Saitama (JP); Ushio HARADA, Saitama (JP); Hiroto MAEYAMA, Saitama (JP); Atsushi OGAWA, Saitama (JP); Soshi KAWAMURA, Saitama (JP); Masahiro OHTA, Saitama (JP)

(73) Assignee: Honda Motor Co.,Ltd., Tokyo (JP)

(21) Appl. No.: 16/726,913

(22) Filed: Dec. 25, 2019

(30) Foreign Application Priority Data
Dec. 26, 2018 (JP) 2018-243306

(51) Int. Cl. H01M 4/80; H01M 4/76; H01M 4/66; H01M 10/0525; H01M 4/13

(52) U.S. Cl. CPC H01M 4/808; H01M 4/762; H01M 4/13; H01M 4/661; H01M 10/0525; H01M 4/667

(57) ABSTRACT

The disclosure provides an electrode for solid state battery and a solid state battery, wherein the electrode using a foamed metal as a collector has excellent mechanical strength and can maintain the insulation from a counter electrode when constituting the solid state battery. In the electrode for solid state battery, which uses a collector composed of a foamed porous body that has a mesh structure, a layer that achieves reinforcement and insulation is provided in the boundary between a filled part filled with an electrode mixture and an unfilled part.

### CROSS-REFERENCE TO RELATED APPLICATION

This application claims the priority benefit of Japan application no. 2018-243306, filed on Dec. 26, 2018. The entirety of the above-mentioned patent application is hereby incorporated by reference herein and made a part of this specification.

### BACKGROUND

### Technical Field

The disclosure relates to an electrode for solid state battery and a solid state battery.

### Description of Related Art

Lithium ion secondary batteries have been widely used as secondary batteries having high energy density. A lithium ion secondary battery has a structure which includes a separator between the positive electrode and the negative electrode and is filled with a liquid electrolyte (electrolytic solution).

Here, since the electrolytic solution of the lithium ion secondary battery is usually a flammable organic solvent, the safety against heat in particular may be a problem. Therefore, a lithium ion solid state battery using an inorganic solid electrolyte instead of an organic liquid electrolyte has been proposed (see Japanese Laid-Open No. 2000-106154).

The lithium ion solid state battery has a structure in which a solid electrolyte layer is disposed between a positive electrode layer and a negative electrode layer. Usually, the positive electrode layer and the negative electrode layer are formed by supporting an electrode mixture, which contains electrode active material powder and solid electrolyte powder, on a metal foil or the like that serves as a collector. In order to increase the capacity of the lithium ion solid state battery, it is necessary to contain a large amount of electrode active material in the electrode layer.

In addition, in order to form a thinner electrode layer to realize a thin solid state battery, it has been proposed to use a collector having a thin mesh structure as the collector that constitutes the positive electrode layer and the negative electrode layer. By filling the inside of the mesh structure with the electrode mixture, the electrode layer can be made thinner. The amount of active material per unit volume can also be increased to increase the capacity of the battery.

A foamed metal, for example, may serve as the collector having such a mesh structure. The foamed metal has advantages when used as the collector for it has uniform pore diameter and large surface area (see Japanese Laid-Open No. H07-099058 and Japanese Laid-Open No. H08-329954).

FIG. 1(a) to FIG. 1(c) show an example of the conventional technology of an electrode using a foamed metal as the collector, and a solid state battery. In order to obtain an electrode using a foamed metal as the collector, first, as shown in FIG. 1(a), the electrode mixture is filled into the mesh structure of the collector 1′ to form a filled part 2′ and an unfilled part 3′. Then, by rolling the collector 1′ filled with the electrode mixture, the filling density of the filled electrode mixture that contains electrode active material is improved and the electrode layer is thinned to obtain the final electrode. The structure of the electrode layer after being stretched is shown in FIG. 1(b).

Usually, when a solid state battery is manufactured, as shown in FIG. 1(c), a solid electrolyte layer 20′ is disposed between the positive electrode layer 10′ and the negative electrode layer 30′ obtained by the above method to form a laminate, and the laminate is sandwiched and pressed from the outer sides of the positive electrode layer 10′ and the negative electrode layer 30′ to obtain the solid state battery.

Here, as shown in FIG. 1(b), the electrode using the foamed metal as the collector is rolled so that the filled part 2′ of the electrode mixture of the collector 1′ becomes a region A′ having a high density. Moreover, in the unfilled part 3′, the portion close to the filled part 2′ becomes a region B′ where the density of the mesh structure of the collector 1′ is low, and the portion away from the filled part 2′ becomes the region A′ where the density of the mesh structure of the collector 1′ is high. This occurs because the unfilled part 3′ of the collector 1′ spreads more easily than the filled part 2′ when the electrode is rolled for the purposes of improving the filling density of the electrode active material contained in the electrode and thinning the electrode.

Then, the electrode shown in FIG. 1(b) has insufficient strength in the region B′ where the density is low in the unfilled part 3′ of the collector 1′ (indicated by X in FIG. 1(c)). In particular, there is a concern that breakage may occur in the region B′ where the density is low during rolling of the electrode or pressing of the laminated electrodes. Furthermore, the conventional solid state battery manufactured by laminating electrodes may break in the region B′ where the density is low in an environment of vibration.

In addition, in the solid state battery which is a laminate, the region B′ where the density is low in the unfilled part 3′ of the collector 1′ may be bent and the collector 1′ may come into contact with the counter electrode and cause a short circuit. In FIG. 1(c), the unfilled part of the collector 1′ of the positive electrode layer 10′ is bent in the direction indicated by the arrow and comes into contact with the negative electrode layer 30′ which is the counter electrode to cause a short circuit. In particular, when the electrodes are laminated, a plurality of unfilled parts are bent and welded. Therefore, the region B′ where the density is low may be bent to an excessive extent and the unfilled part 3′ of the collector 1′ may be brought close to the counter electrode and cannot maintain the insulation.

Furthermore, when the laminated electrodes are pressed, a desired pressure may not be applied to the end portion of the electrode that faces the region B′ where the density is low, and the filling density may be non-uniform in the plane.

In view of the above background technology, the disclosure provides an electrode for solid state battery and a solid state battery, wherein the electrode using a foamed metal as a collector has excellent mechanical strength and can maintain the insulation from the counter electrode when constituting the solid state battery.

The inventors found that the above-mentioned problem can be solved if a layer that achieves reinforcement and insulation is provided in the boundary between the filled part filled with the electrode mixture and the unfilled part in the electrode for solid state battery which uses a collector composed of a foamed porous body having a mesh structure, and completed the disclosure.

### SUMMARY

The disclosure provides an electrode for solid state battery, including: a collector composed of a conductive foamed porous body; and an electrode mixture filled in the collector, wherein the collector includes a filled part filled with the electrode mixture, and an unfilled part not filled with the electrode mixture. The electrode for solid state battery includes a reinforcing insulation layer composed of a resin in a boundary part between the filled part and the unfilled part.

The disclosure further provides a solid state battery, including: a positive electrode layer including a positive electrode active material; a negative electrode layer including a negative electrode active material; and a solid electrolyte layer positioned between the positive electrode layer and the negative electrode layer, wherein at least one of the positive electrode layer and the negative electrode layer is composed of the electrode for solid state battery mentioned above.

### BRIEF DESCRIPTION OF THE DRAWINGS

FIG. 1(a) to FIG. 1(c) show the conventional technology of an electrode using a foamed metal as the collector and a solid state battery.

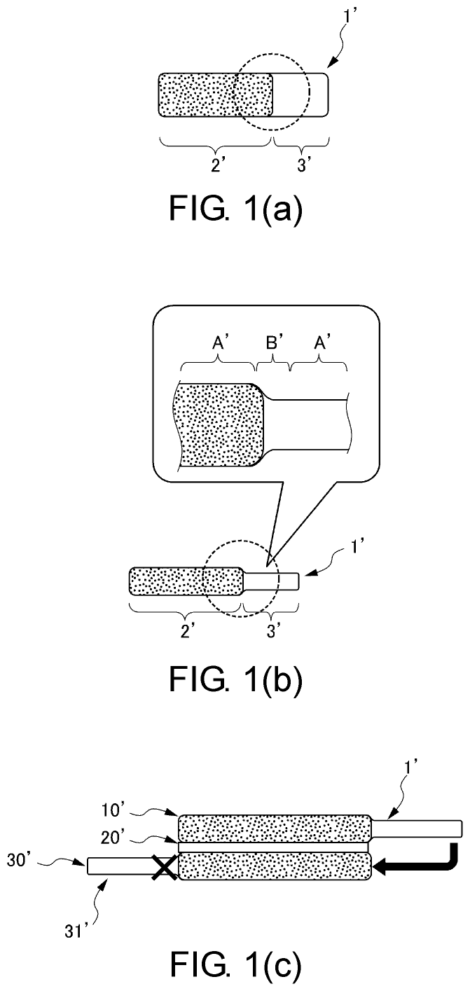

FIG. 2(a) to FIG. 2(c) are diagrams showing an embodiment of a manufacturing method of an electrode for solid state battery according to the disclosure.

FIG. 3(a) to FIG. 3(c) are diagrams showing an embodiment of an electrode for solid state battery and a solid state battery according to the disclosure.

### DESCRIPTION OF THE EMBODIMENTS

The disclosure provides an electrode for solid state battery, including: a collector composed of a conductive foamed porous body; and an electrode mixture filled in the collector, wherein the collector includes a filled part filled with the electrode mixture, and an unfilled part not filled with the electrode mixture. The electrode for solid state battery includes a reinforcing insulation layer composed of a resin in a boundary part between the filled part and the unfilled part.

The resin of the reinforcing insulation layer may be filled in the collector.

The resin of the reinforcing insulation layer may be coated on the boundary part.

The collector may be a foamed porous body of a metal.

A tab may be connected to the unfilled part.

The electrode for solid state battery may be a positive electrode.

The electrode for solid state battery may be a negative electrode.

The disclosure further provides a solid state battery, including: a positive electrode layer including a positive electrode active material; a negative electrode layer including a negative electrode active material; and a solid electrolyte layer positioned between the positive electrode layer and the negative electrode layer, wherein at least one of the positive electrode layer and the negative electrode layer is composed of the electrode for solid state battery mentioned above.

Even if the electrode for solid state battery of the disclosure uses a foamed metal as the collector, the electrode has excellent mechanical strength and can maintain the insulation from the counter electrode when constituting a solid state battery. Therefore, the solid state battery obtained by using the electrode for solid state battery of the disclosure can suppress breakage of the collector that constitutes the electrode even in an environment of vibration, and also prevent a short circuit that occurs when the end portion of the collector comes into contact with the counter electrode. Furthermore, the filling density of the electrode can be made uniform.

Hereinafter, embodiments of the disclosure will be described with reference to the drawings.

### <Electrode for Solid State Battery>

An electrode for solid state battery of the disclosure includes a collector composed of a conductive foamed porous body, and an electrode mixture filled in the collector. The collector has a filled part filled with the electrode mixture and an unfilled part not filled with the electrode mixture, and has a reinforcing insulation layer composed of a resin in a boundary part between the filled part and the unfilled part.

The electrode for solid state battery of the disclosure can be used without any problem when applied as the positive electrode, the negative electrode, or both in a solid state battery.

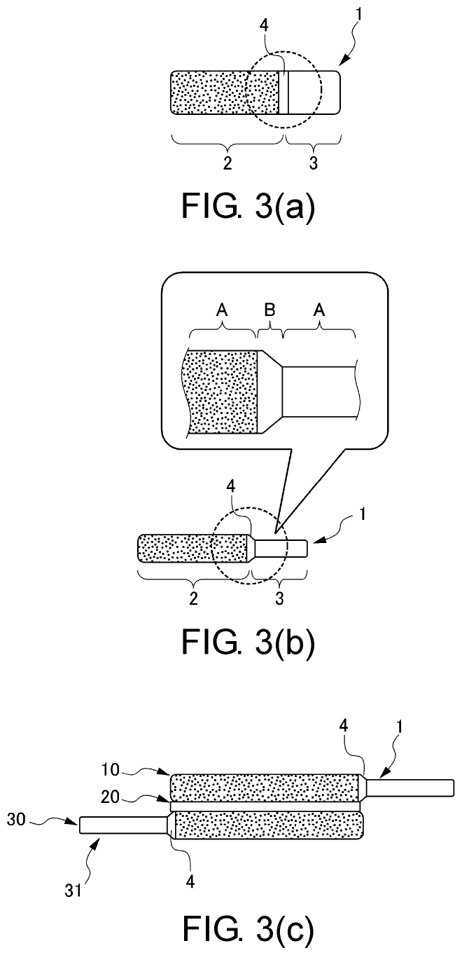

An embodiment of the electrode for solid state battery according to the disclosure is shown in FIG. 3(a) to FIG. 3(c). FIG. 3(a) is a top view of the electrode for solid state battery according to the disclosure, and FIG. 3(b) is a side view and an enlarged view. The electrode for solid state battery of the disclosure has a filled part 2 filled with an electrode mixture and an unfilled part 3 not filled with the electrode mixture in a collector 1, and has a reinforcing insulation layer 4. As shown in FIG. 3(b), in the electrode for solid state battery of the disclosure, the reinforcing insulation layer 4 is present in a region B, in which the density of the collector 1 is lowered due to rolling in the conventional electrode.

### [Electrode Mixture]

In the disclosure, the electrode mixture filled in the collector of the foamed porous body is not particularly limited as long as it can be used for manufacturing the solid state battery.

In the case of the electrode mixture that constitutes the positive electrode, the electrode mixture contains at least a positive electrode active material and may further contain a solid electrolyte, a conductive aid, a binder and the like. The positive electrode active material is not particularly limited as long as it can occlude and release lithium ions, and may be LiCoO₂, LiCoO₄, LiMn₂O₄, LiNiO₂, LiFePO₄, lithium sulfide, sulfur, etc., for example.

In the case of the electrode mixture that constitutes the negative electrode, the electrode mixture contains at least a negative electrode active material and may contain a solid electrolyte, a conductive aid, a binder and the like as required. The negative electrode active material is not particularly limited as long as it can occlude and release lithium ions, and may be metal lithium, lithium alloy, metal oxide, metal sulfide, metal nitride, silicon oxide, silicon, a carbon material such as graphite, etc., for example.

In addition, when a solid state battery is manufactured using the electrode for solid state battery of the disclosure, at least one of the positive electrode layer and the negative electrode layer may be the electrode for solid state battery of the disclosure. Therefore, for the negative electrode layer, it is also possible to use a metal or the carbon material that serves as the negative electrode active material directly as a sheet.

### [Collector]

The collector used in the electrode for solid state battery of the disclosure is a conductive foamed porous body. The conductive foamed porous body is not particularly limited as long as it is a porous body obtained by foaming a conductive material. By using the conductive foamed porous body as the collector, it is easy to fix the electrode mixture so the thickness of the electrode layer can be increased without thickening the coating slurry of the electrode mixture. In addition, since the binder composed of an organic polymer compound, which is necessary for thickening, can be reduced, it can contribute to high capacity while keeping the resistance low when the solid state battery is constituted.

The surface of the collector used in the electrode for solid state battery of the disclosure may be processed by a surface treatment in order to improve the bondability between the electrode mixture filled in the foamed porous body and the foamed porous body. The surface treatment may be coating with a carbon material such as graphite, chemical modification with hydrochloric acid, oxalic acid, ammonia, etc., for example.

The collector used in the electrode for solid state battery of the disclosure is preferably a foamed porous body of a metal, that is, a foamed metal. The metal may be nickel, aluminum, stainless steel, titanium, copper, silver, etc., for example.

Since the foamed metal has a three-dimensional mesh structure, it can improve the current collection performance and the retention performance for the active material as compared with other conventional collectors. Therefore, as compared with using a metal foil as a collector, the thickness of the mixture layer can be increased without an increase in resistance, and as a result, the capacity per unit area of the electrode can be increased. In addition, for example, since the porosity of the foamed metal is higher than that of a metal fiber sintered body, the filling amount of the active material can be increased, and as a result, the capacity of the electrode can be increased.

### (Filled Part and Unfilled Part)

The collector of the electrode for solid state battery of the disclosure has the filled part filled with the above-mentioned electrode mixture and the unfilled part not filled with the electrode mixture. In addition, a tab may be connected to the unfilled part.

### (Reinforcing Insulation Layer)

The collector of the electrode for solid state battery of the disclosure is characterized in including the reinforcing insulation layer in the boundary part between the filled part filled with the electrode mixture and the unfilled part not filled with the electrode mixture.

Since the electrode for solid state battery of the disclosure has the reinforcing insulation layer, it is possible to reinforce the strength of the region of the electrode mixture unfilled part that is near the electrode mixture filled part of the collector composed of the foamed porous body, which raises concern over breakage in the conventional battery. In addition, it is possible to suppress excessive bending in the region where the density is low in the electrode mixture unfilled part of the collector. Therefore, when used in a solid state battery, the electrode for solid state battery of the disclosure can suppress breakage of the collector composed of the foamed porous body and prevent a short circuit that occurs when the collector comes into contact with the counter electrode.

The reinforcing insulation layer in the electrode for solid state battery of the disclosure is formed of a resin. The resin that can be used may be a polyimide resin, an epoxy resin, a silicone resin, a polyurethane resin, etc. in the case of a thermosetting resin, a polyolefin resin, a polystyrene resin, a fluorine resin, a polyvinyl chloride resin, a polymethacrylic acid resin, a polyurethane resin, etc. in the case of a thermoplastic resin, and a silicone resin, a polymethacrylic acid resin, a polyester resin, etc. in the case of a photocurable resin, for example. Among these, polyethylene resin and polypropylene resin are preferable from the perspectives that they are electrically insulating against contact with the counter electrode, inert to the electrode mixture, resistant to the chemicals used during electrode production, have good workability in formation of the reinforcing insulation layer, and have excellent heat resistance and flexibility.

The width of the reinforcing insulation layer in the electrode for solid state battery of the disclosure is not particularly limited as long as it can reinforce the strength and suppress excessive bending. For example, the width is preferably 1 mm to 1 μm, and more preferably 500 μm to 10 μm.

### <Manufacturing Method of Electrode for Solid State Battery>

A manufacturing method of the electrode for solid state battery of the disclosure is not particularly limited, and an ordinary method in the technical field can be applied.

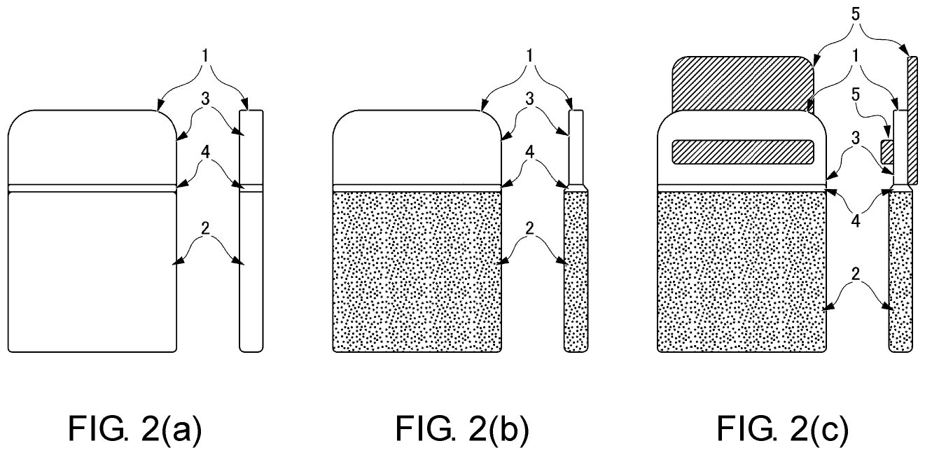

FIG. 2(a) to FIG. 2(c) show an embodiment of the manufacturing method of the electrode for solid state battery according to the disclosure. In the method shown in FIG. 2(a) to FIG. 2(c), first, the collector 1 is formed with the reinforcing insulation layer 4. FIG. 2(a) shows a top view and a side view of the collector 1 after the reinforcing insulation layer 4 is formed. FIG. 2(a) shows the filled part 2 to be filled with the electrode mixture in the next process, and the unfilled part 3 not to be filled.

Subsequently, the collector 1 formed with the reinforcing insulation layer 4 is filled with the electrode mixture to form the filled part 2 and the unfilled part 3, and thereafter the collector 1 is rolled to obtain the electrode for solid state battery of the disclosure. FIG. 2(b) shows a top view and a side view of the collector 1 after rolling. A tab 5 may be connected to the obtained electrode for solid state battery of the disclosure as shown in FIG. 2(c). In the process shown in FIG. 2(c), the tab 5 is welded so as to sandwich the unfilled part 3 of the electrode mixture of the collector 1.

Although the electrode for solid state battery of the disclosure is characterized in including the reinforcing insulation layer, the reinforcing insulation layer may be formed before or after the electrode mixture is filled into the collector. Since the strength of the reinforcing insulation layer can be sufficiently satisfied at the time of electrode production, the reinforcing insulation layer is preferably formed in advance before the electrode mixture is filled into the collector. In addition, if the reinforcing insulation layer is formed after the electrode mixture is filled, the reinforcing insulation layer may be formed before or after rolling. The reinforcing insulation layer is preferably formed after rolling for the dimensions of the reinforcing insulation layer can be controlled.

Moreover, the method of forming the reinforcing insulation layer is not particularly limited. For example, the reinforcing insulation layer may be filled into the collector before the electrode mixture is filled, or may be formed by coating in the boundary between the filled part and the unfilled part after the electrode mixture is filled.

### <Solid State Battery>

A solid state battery of the disclosure includes a positive electrode layer including a positive electrode active material, a negative electrode layer including a negative electrode active material, and a solid electrolyte layer positioned between the positive electrode layer and the negative electrode layer. In the solid state battery of the disclosure, at least one of the positive electrode layer and the negative electrode layer is the electrode for solid state battery of the disclosure described above.

In the solid state battery of the disclosure, the positive electrode layer may be the electrode for solid state battery of the disclosure or the negative electrode layer may be the electrode for solid state battery of the disclosure, or both may be the electrode for solid state battery of the disclosure.

### [Positive Electrode Layer and Negative Electrode Layer]

In the solid state battery of the disclosure, the positive electrode layer and the negative electrode layer that do not use the electrode for solid state battery of the disclosure are not particularly limited as long as they function as the positive electrode and the negative electrode of a lithium ion solid state battery.

The positive electrode and the negative electrode that constitute the solid state battery can constitute any battery by selecting two types of materials from the materials that can constitute the electrodes, comparing the charge/discharge potentials of two types of compounds, and using the compound showing a high potential in the positive electrode and the compound showing a low potential in the negative electrode.

If the electrode for solid state battery of the disclosure is used only in the positive electrode layer of the solid state battery, it is also possible to use a metal or a carbon material that serves as the negative electrode active material directly as a sheet to serve as the negative electrode layer.

### [Solid Electrolyte]

The solid electrolyte contained in the solid electrolyte layer used in the solid state battery of the disclosure is not particularly limited as long as it allows lithium ion conduction between the positive electrode and the negative electrode. For example, the solid electrolyte may be an oxide-based electrolyte or a sulfide-based electrolyte, an inorganic solid electrolyte such as lithium-containing salt, a polymer-based solid electrolyte such as polyethylene oxide, a gel-based solid electrolyte containing lithium-containing salt or lithium ion conductive ionic liquid, etc., for example. In addition, the solid electrolyte may contain a binder and the like as required. The composition ratio of each substance contained in the solid electrolyte is not particularly limited as long as the battery can operate properly.

The solid electrolyte layer used in the solid state battery of the disclosure may be in the form of a sheet. The solid electrolyte sheet is disposed between the positive electrode layer and the negative electrode layer. In addition, if at least one of the positive electrode layer and the negative electrode layer described above has the solid electrolyte layer, the solid state battery of the disclosure can be constituted without using the solid electrolyte sheet.

The solid electrolyte sheet is not particularly limited and may be a dense sheet composed of an inorganic solid electrolyte and a binder, a composite sheet obtained by embedding a solid electrolyte in a porous sheet such as non-woven fabric made of polypropylene, cellulose, glass and the like, an organic solid electrolyte sheet, etc., for example.

An embodiment of the solid state battery of the disclosure is shown in FIG. 3(c). FIG. 3(c) is a side view of the electrode for solid state battery of the disclosure. In the solid state battery shown in FIG. 3(c), the electrode for solid state battery of the disclosure is used in both the positive electrode layer 10 and the negative electrode layer 30, and a laminate is formed with the solid electrolyte layer 20 sandwiched therebetween. The collector 1 constituting the positive electrode layer 10 and the collector 31 constituting the negative electrode layer 30 have the reinforcing insulation layer 4 in the boundary between the filled part filled with the electrode mixture and the unfilled part not filled with the electrode mixture.

In the solid state battery of the disclosure, from the perspectives of safety and durability, it is desirable that the areas of the positive electrode layer, the solid electrolyte layer, and the negative electrode layer satisfy “positive electrode layer ≤ negative electrode layer ≤ solid electrolyte layer”. As to the electrode capacity, it is desirable that “positive electrode layer ≤ negative electrode layer”.

In the solid state battery of the disclosure, the electrode for solid state battery of the disclosure used in at least one of the positive electrode layer and the negative electrode layer has the reinforcing insulation layer. Therefore, it is possible to reinforce the strength of the region of the electrode mixture unfilled part that is near the electrode mixture filled part of the collector composed of the foamed porous body, which raises concern over breakage in the conventional battery. In addition, it is possible to suppress excessive bending in the region where the density is low in the electrode mixture unfilled part of the collector. Furthermore, when pressing is performed during production of the laminated electrode, a predetermined pressure can be applied to the end portion of the electrode that faces the region where the density is low in the electrode mixture unfilled part. Therefore, the solid state battery of the disclosure can suppress breakage of the collector composed of the foamed porous body and prevent a short circuit that occurs when the collector comes into contact with the counter electrode, and obtain an electrode with uniform filling density.

What is claimed is:

1. An electrode for solid state battery, comprising:
a collector composed of a conductive foamed porous body; and
an electrode mixture filled in the collector,
wherein the collector comprises a filled part filled with the electrode mixture, and an unfilled part not filled with the electrode mixture, and
the electrode for solid state battery comprises a reinforcing insulation layer composed of a resin in a boundary part between the filled part and the unfilled part.

2. The electrode for solid state battery according to claim 1, wherein the resin of the reinforcing insulation layer is filled in the collector.

3. The electrode for solid state battery according to claim 1, wherein the resin of the reinforcing insulation layer is coated on the boundary part.

4. The electrode for solid state battery according to claim 1, wherein the collector is a foamed porous body of a metal.

5. The electrode for solid state battery according to claim 1, wherein a tab is connected to the unfilled part.

6. The electrode for solid state battery according to claim 1, wherein the electrode for solid state battery is a positive electrode.

7. The electrode for solid state battery according to claim 1, wherein the electrode for solid state battery is a negative electrode.

8. A solid state battery, comprising:
a positive electrode layer comprising a positive electrode active material;
a negative electrode layer comprising a negative electrode active material; and
a solid electrolyte layer positioned between the positive electrode layer and the negative electrode layer,
wherein at least one of the positive electrode layer and the negative electrode layer is composed of the electrode for solid state battery according to claim 1.

9. The solid state battery according to claim 8, wherein the resin of the reinforcing insulation layer is filled in the collector.

10. The solid state battery according to claim 8, wherein the resin of the reinforcing insulation layer is coated on the boundary part.

11. The solid state battery according to claim 8, wherein the collector is a foamed porous body of a metal.

12. The solid state battery according to claim 8, wherein a tab is connected to the unfilled part.

13. The solid state battery according to claim 8, wherein the electrode for solid state battery is a positive electrode.

14. The solid state battery according to claim 8, wherein the electrode for solid state battery is a negative electrode.
